(19) United States
(12) Patent Application Publication
(10) Pub. No.: US 2012/0251744 A1
(43) Pub. Date: Oct. 4, 2012

(54) METALLIC PART PROVIDED WITH FIBROUS REINFORCEMENTS AND HAVING A BEVELLED EDGE

(75) Inventors: Richard Masson, Les Loges En Josas (FR); Patrick Dunleavy, Palaiseau (FR); Jean-Michel Franchet, Paris (FR); Gilles Klein, Mery Sur Oise (FR)

(73) Assignee: MESSIER-BUGATTI-DOWTY, VELIZY VILLACOUBLAY (FR)

(21) Appl. No.: 13/395,357

(22) PCT Filed: Sep. 13, 2010
(86) PCT No.: PCT/EP2010/005593

§ 371 Date: Mar. 9, 2012

(30) Foreign Application Priority Data
Sep. 11, 2009 (EP) 09 04370

(51) Int. Cl. B32B 15/14

(52) U.S. Cl. 428/34.5

(57) ABSTRACT

The invention relates to a mechanical part made from a metal preform presenting at least one housing (5) that extends longitudinally relative to a preferred direction for the application of forces to the mechanical part in service, and into at least one piece of fiber reinforcement is inserted and then bonded to the blank by hot isostatic compression, wherein the piece of fiber reinforcement (10) presents a chamfered end (12).

### TECHNOLOGICAL BACKGROUND OF THE INVENTION

Document WO 2009/034264 discloses a link rod that is fabricated as follows: making a metal blank having two parallel oblong housings on either side of a plane of symmetry of the link rod; inserting pieces of fiber reinforcement into the housings, the pieces being made from carbide fibers sheathed in a metal that is compatible with the metal of the container; and subjecting the assembly to a vacuum and to hot isostatic compression so as to achieve intimate bonding between the fibers of the fiber reinforcement and the metal of the blank by metal diffusion around the fibers.

The metal sheathing the carbide fibers melts and mixes with the adjacent metal of the metal preform so as to provide a metallic continuum intimately surrounding the fibers of the fiber reinforcement. It then remains to machine the blank in order to obtain the link rod (in particular piercing orifices for the lugs).

In general, the pieces of fiber reinforcement present at least one end that is completely embedded in the metal of the part and that presents a terminal face that extends transversely relative to the fibers. At this location there therefore exists a sudden step-change in the stiffness of the part, so transmitting stresses between the pieces of fiber reinforcement and the container runs the risk of bonding being lost or of fibers being pulled out, and thus of starting cracks. Furthermore, internal stresses in this zone are generally perpendicular to the fibers, such that this zone is already weakened.

### OBJECT OF THE INVENTION

The invention seeks to provide mechanical parts made of metal provided with at least one piece of fiber reinforcement in which the above-mentioned drawback is attenuated or even eliminated.

### BRIEF SUMMARY OF THE INVENTION

To this end, a mechanical part is provided that is fabricated from a metal blank presenting at least one housing extending substantially along a preferred direction for the application of forces to the mechanical part in service, and into which at least one piece of fiber reinforcement is inserted and then intimately bonded to the blank by metal diffusion around the fibers of the fiber reinforcement so as to present at least one end that is completely embedded in the metal of the part. According to the invention, said end extends at a chamfer.

Thus, the interface that extends at the end of the fiber reinforcement between the reinforcement and the metal of the blank is oblique relative to the forces that pass via the mechanical part, thus making it possible to adapt the stiffness of the part progressively in the direction of the fiber reinforcement. This provision attenuates the risk of the fiber reinforcement becoming unbonded from the remainder of the metal.

### BRIEF DESCRIPTION OF THE FIGURES

FIG. 1 is a diagrammatic plan view of a link rod of the invention, showing the oblique ends of the fiber reinforcement in a first particular embodiment of the invention;

FIG. 2 is a perspective view of the end of a piece of fiber reinforcement, in a second particular embodiment of the invention;

FIG. 3 is a perspective view from above of the end of a piece of fiber reinforcement in a third particular embodiment of the invention; and

FIG. 4 is a face view from above of another link rod of the invention, showing the oblique ends of the fiber reinforcement.

### DETAILED DESCRIPTION OF THE FIGURES

In the explanation below, making the fiber reinforcement does not constitute the subject matter of the invention and it is therefore not described in detail. Reference may be made for example to document WO 2009/034264, which describes several embodiments of such fiber reinforcement.

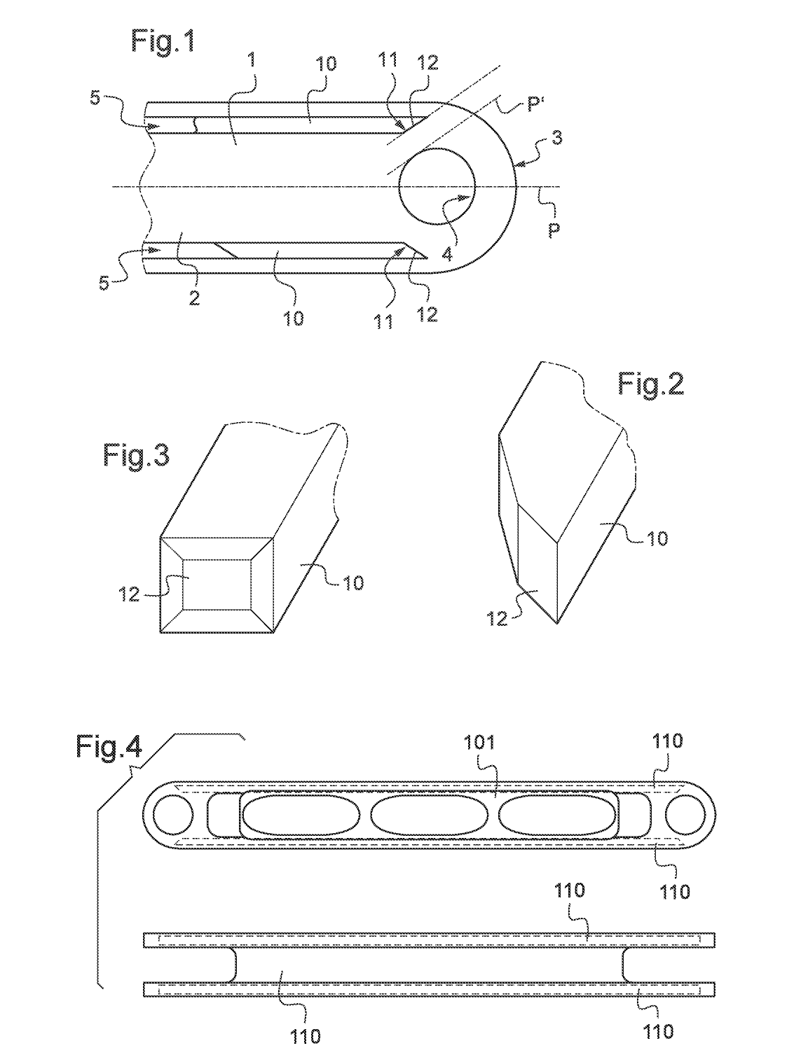

With reference to FIG. 1, the link rod of the invention in a first embodiment is made from a metal blank 1 that is generally flat in shape and presents a main portion 2 of constant section that is terminated by two rounded end portions 3 forming end lugs and including through orifices 4. In this example the blank is made of titanium alloy.

In this example, longitudinal housings 5 extend parallel to the plane of symmetry P of the blank 1 from one of its ends to the other, and they form housings suitable for receiving pieces of fiber reinforcement 10 (the pieces of fiber reinforcement are shown as being cut in order to show the housings more clearly, but in reality they occupy the housings over their full length). It should be observed that the plane of symmetry P is parallel to a preferred direction for applying forces to the link rod (essentially traction and compression forces along the axis of the rod).

The pieces of fiber reinforcement 10 comprise fibers that extend longitudinally. In this example, the fibers are titanium-sheathed silicon-carbide fibers. Preferably, the fibers are bonded together prior to being put into place in the grooves by subjecting them to hot isostatic compression.

According to the invention, the housings 5 have ends 11 that are oblique relative to the plane of symmetry P, extending in this example parallel to a plane P′ that is tangential to the adjacent through orifice. The oblique ends 11 may be obtained in various ways. In preferred manner, the grooves are machined in the metal blank along its entire length such that the grooves open out into the edge face of the blank. Thereafter a titanium plug is fitted to each end of the groove, the plug having a chamfered terminal portion defining the chamfered end of the corresponding housing, the plugs preferably being put into place after the fiber reinforcement has been put into position in the grooves. The plugs may be made of single-block pieces of titanium, or they may be made by compacting a metal powder.

According to the invention, the pieces of fiber reinforcement are of a shape that is complementary to the shape of the housings, and they thus present ends 12 that are chamfered and compatible with the oblique ends of the housings.

The fiber reinforcement 10 is covered by blocks of titanium alloy serving to close the housings 5. These blocks may be integral with the plugs that close the housings.

Thereafter, the sealed assembly is put into a vacuum and is then subjected to hot isostatic compression so that the metal sheathing of the fibers melts and diffuses so as to form a metal compound with the metal of the blank and of the blocks, thus ensuring intimate bonding between the fibers and the surrounding metal. This produces a composite material part with a metal matrix.

The chamfers at the ends of the pieces of fiber reinforcement are completely embedded in the metal of the part and they serve to transfer forces between the ends of the fibers and the surrounding metal in such a manner that the forces on the fibers are no longer pull-out forces only, but include shear forces, thereby reducing the risk of the fibers becoming unbonded in these locations, and creating transition zones that avoid too great a step-change in stiffness.

In a second embodiment of the invention shown in FIG. 2, the end of a piece of reinforcement is chamfered with two slopes. In a third embodiment of the invention as shown in FIG. 3, a piece of fiber reinforcement is chamfered on each face. These second and third embodiments may be made by chamfering the fiber reinforcement and they avoid forming a sharp point that would weaken the fiber reinforcement while it is being handled.

FIG. 4 shows the invention implemented in a link rod 101 that has four pieces of fiber reinforcement 110 that are chamfered in accordance with the invention.

It should naturally be observed that the chamfer of the invention has nothing whatever to do with the chamfer mentioned in document EP 1 726 678, which specifies the angle with which the end of the reinforcing sheet is cut, which angle serves to impart a helix angle to the sheet while it is being laid. In any event, it should be observed that that end is tangential to the edge of the tubular part covered by the sheet and that it is therefore not embedded.

1. A mechanical part made from a metal preform presenting at least one housing extending substantially along a preferred direction for the application of forces to the mechanical part in operation, and into which at least one piece of fiber reinforcement is inserted and then bonded to the blank by metal diffusion around fibers of the piece of fiber reinforcement such that at least one of its ends is entirely embedded in the metal forming the mechanical part, wherein said end extends along a chamfer.

2. A mechanical part according to claim 1, wherein the end of the piece of fiber reinforcement is chamfered with two slopes.

3. A mechanical part according to claim 1, wherein the end of the piece of fiber reinforcement is chamfered from each of the faces of the piece.
